(19) United States
(12) Patent Application Publication
(10) Pub. No.: US 2026/0169438 A1
(43) Pub. Date: Jun. 18, 2026

(54) FASTENING DEVICE FOR HOROLOGY MOVEMENT

(71) Applicant: The Swatch Group Research and Development Ltd, Marin (CH)

(72) Inventors: Joslain BOSSY, Yverdon-les Bains (CH); Simon GARCIN, Salavaux (CH); Yoann MOSTEIRO VAZQUEZ, Montmagny (CH)

(73) Assignee: The Swatch Group Research and Development Ltd, Marin (CH)

(21) Appl. No.: 19/378,925

(22) Filed: Nov. 4, 2025

(30) Foreign Application Priority Data
Dec. 17, 2024 (EP) 24220750.4

(51) Int. Cl. G04B 37/05

(52) U.S. Cl. CPC G04B 37/052

(57) ABSTRACT

A device (10) for fastening a horology movement (2) designed to hold the horology movement (2) in a case (4) of a timepiece (1). The device includes at least one stack (3) with at least two blades (3a, 3b), the at least one stack (3) having two opposite ends, a first case end (3c) and a second movement end (3d). The device also includes first fastening elements (7) for fastening the second movement end (3d) of the at least one stack (3) to the horology movement (2), the at least one stack (3) being configured to rigidly hold the horology movement (2) in the case (4).

### CROSS-REFERENCE TO RELATED APPLICATIONS

This application claims priority to European Patent Application No. 24220750.4, filed on December 17, 2024, the entire contents of which are incorporated herein by reference.

### TECHNICAL FIELD OF THE INVENTION

The present invention relates to a fastening device for fastening a horology movement in a timepiece case.

The invention also relates to a timepiece comprising such a fastening device.

### TECHNOLOGICAL BACKGROUND

Two or three casing clamps are generally used to assemble or fasten a horology movement inside a case, particularly inside a middle.

The casing clamps ensure that the horology movement is rigidly held in the watchcase.

These casing clamps are rarely dimensioned to withstand the effects of shocks to the case. Such shocks can lead to the loss of anchor points or to bending of the clamps, which amplifies the acceleration undergone by the horology movement and can cause damage to the horology movement.

Consequently, there is a need to improve fastening devices for horology movements.

### SUMMARY OF THE INVENTION

To this end, the invention provides a device for fastening a horology movement in a case, making it possible to remedy at least one of the aforementioned drawbacks.

In particular, the invention provides a fastening device for a horology movement with improved rigidity and limited space requirements for holding the horology movement in a case of a timepiece with sufficient rigidity to minimise the accelerations undergone by the horology movement as a result of a shock.

Moreover, the invention provides a fastening device with improved reliability and robustness compared with solutions in the prior art.

According to the invention, the fastening device comprises:

at least one stack consisting of at least two blades, said at least one stack having two opposite ends, a first case end and a second movement end,

first fastening elements for fastening the second movement end of said at least one stack to the horology movement,

said at least one stack being configured to rigidly hold said horology movement in the case.

The fastening device according to the invention enables the horology movement to be rigidly connected to the case. Stacking several blades makes it possible to increase the rigidity of conventional state-of-the-art clamps while minimising the space required.

The fastening device according to the invention applies to both blade-type fastening devices in which the blades are clamped on either side by fastening elements, such as screws, and to retaining clamps attached to the movement and which force the horology movement against a shoulder of the middle by engaging with notches provided for this purpose in the middle.

Stacking several blades also makes it possible to increase the yield strength of the fastening device in a horology movement in response to a shock.

In addition to the characteristics mentioned in the previous paragraph, the fastening device according to the invention can have one or more complementary characteristics from among the following, taken individually or in any technically possible combination:

the fastening device comprises second fastening elements for fastening the first case end of said at least one stack to the case;

the first case end of said at least one stack is clamped to the case by engaging a bed in the case;

the at least two blades in a stack are at least partially in contact with each other;

the at least two blades in a stack are spaced apart by at least one spacer arranged between said at least two blades;

the at least two blades have identical dimensions and/or identical mechanical properties, for example in terms of width and/or thickness and/or of Young's modulus and/or of yield strength of the material in question;

the at least two blades have different dimensions and/or different mechanical properties, for example in terms of width and/or thickness and/or of Young's modulus and/or of yield strength of the material in question;

the fastening device comprises at least two stacks preferably at least three stacks preferably at least four stacks, preferably at least five stacks, preferably six stacks;

the at least two stacks are arranged so as to form a circular repeating pattern;

at least two stacks are arranged angularly equidistant from each other around the horology movement;

the first fastening elements comprise at least one screw;

the second fastening elements comprise at least one screw;

the at least two blades in said at least one stack comprise a material chosen among: steel, resilient steel, superelastic shape memory alloy, amorphous metal, nickel-based superalloy, iron-nickel-based superalloy, cobalt-based superalloy, spring steel, composite materials, or a mixture or combination thereof;

the fastening device comprises a casing support into which the horology movement is clamped, and said at least one stack is fastened to the casing support via its second movement end.

Preferably the at least two blades are at least partially superimposed.

For example, the fastening device can comprise at least two stacks extending substantially tangentially relative to a circle that runs through the fastening points on the stacks in the horology movement. "Substantially tangentially" is taken to mean in a direction forming an angle comprised between 80° and 100° relative to the radius of the circle that runs through the fastening points on the stacks in the horology movement.

According to another aspect, the invention provides a horology device comprising a horology movement and a case configured to hold said horology movement comprising a fastening device according to one or more of the characteristics described above connecting the horology movement to the case.

### BRIEF DESCRIPTION OF THE FIGURES

Other features and advantages of the invention will be apparent from the following detailed description of the invention, with reference to the attached figures, in which:

FIG. 1 is a perspective view of a horology movement and of a fastening device according to a first embodiment of the invention; in this first embodiment, the fastening device comprises four stacks of several blades designed to be clamped by screwing;

FIG. 2 is a perspective view of the assembly illustrated in FIG. 1, shown on top of a bed in a case of a horology part;

FIG. 3 is a perspective view of a timepiece comprising the horology movement fitted in the case using the fastening device according to the invention;

FIG. 4 is a perspective view of a horology movement and of a fastening device according to a second embodiment of the invention; in this second embodiment, the fastening device comprises four stacks of several blades.

For greater clarity, identical or similar elements in the different embodiments are labelled with identical reference numbers in all figures.

### DETAILED DESCRIPTION OF THE INVENTION

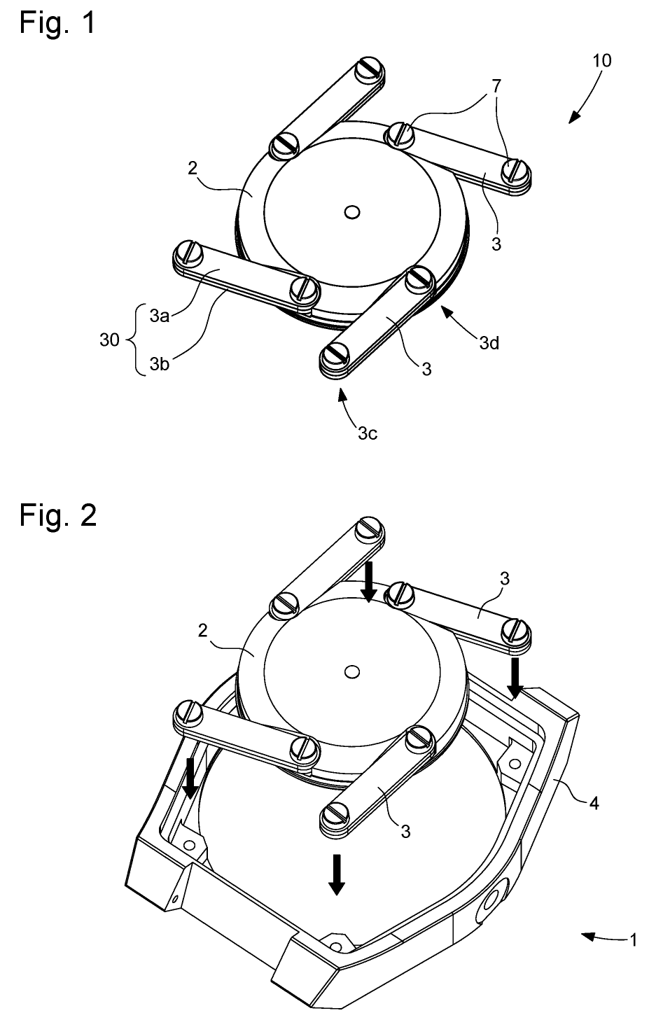

FIGS. 1 to 3 describe a fastening device 10 for a horology movement 2 designed to hold said horology movement 2 in a case 4 of a timepiece 1.

In this first embodiment, the fastening device is of the type comprising at least one casing blade that is screwed on at both of its ends.

The fastening device 10 according to the invention makes it possible to rigidly connect the horology movement 2 to the case 4 and to minimise or control the acceleration undergone by the horology movement 2 as a result of a shock.

The fastening device 10 according to the invention can also be used to connect the horology movement 2 to an intermediate casing support (not shown) and to connect an intermediate casing support to the case 4.

The fastening device 10 according to the invention comprises at least one stack 3 formed by at least two blades 3a, 3b acting as a casing clamp for the horology movement 2.

Preferentially, the at least two blades 3a, 3b in a stack 3 are at least partially superimposed.

The blades 3a, 3b in a stack 3 can be in direct contact, or a space can be created between two superimposed blades, at least over a portion of the stack 3, so that they are not in direct contact at least over this portion. The space between two superimposed blades can be created by adding spacers between two consecutive superimposed blades.

In the example shown, the fastening device 10 comprises four stacks 3, each stack 3 consisting of two superimposed blades, preferentially in direct contact with each other.

However, the fastening device 10 can comprise at least two stacks 3, preferentially up to six stacks with identical or different mechanical or geometric characteristics.

Each stack 3 in the fastening device 10 can comprise a plurality of blades, preferentially superimposed and in contact.

The number of superimposed blades in a stack 3 and the thickness of the blades are chosen according to the desired target rigidity.

In the example shown in FIGS. 1 to 3, the blades 3a, 3b have identical dimensions.

However, the various blades 3a, 3b forming a stack 3 can have different dimensions and/or different mechanical properties, for example in terms of width and/or thickness and/or of Young's modulus.

The various blades 3a, 3b in two separate stacks 3 can also have different dimensions and/or different mechanical properties, for example in terms of width and/or thickness and/or of Young's modulus.

Preferably, the material of the blades 3a, 3b is chosen from the following list: steel, resilient steel, superelastic shape memory alloy, amorphous metal, nickel-based superalloy, iron-nickel-based superalloy, cobalt-based superalloy, spring steel, composite materials, or a mixture or combination thereof.

For example, the blades 3a, 3b are straight.

For example, the blades 3a, 3b can have one or more of the following characteristics: thickness comprised between 0.2 and 2 mm, width comprised between 2 and 6 mm, and length comprised between 8 and 25 mm.

Each stack 3 has two opposite ends, a first case end 3c and a second movement end 3d. Each end 3c, 3d has an axial or cylindrical hole suitable for the passage of a fastening element of the stack 3 ensuring the reversible attachment of the stack 3 to the case 4 and to the horology movement 2, so as to rigidly fit the horology movement 2 into the case 4.

The fastening device 10 comprises first and second fastening elements 7, such as screws, with threaded bodies designed to pass through the holes in the stacks 3 and to engage with fastening points formed by tappings in the horology movement 2 and in the case 4.

The stacks 3 are thus rigidly clamped by screwing their two ends 3d, 3c to the horology movement 2 and to the case 4, respectively. The stacks 3 can also be clamped by other equivalent means known to the person skilled in the art to ensure rigid and reversible attachment.

Preferably, the various stacks 3 in the fastening device 10 are arranged angularly equidistant from each other around the horology movement 2.

Preferably, the various stacks 3 form a circular repeating pattern around the horology movement 2.

Preferably, the fastening points on the horology movement are arranged so as to be inscribed on a first circle.

Preferably, the fastening points on the case 4 are arranged so as to be inscribed on a second circle, concentric with the first circle.

According to the embodiment shown, the stacks 3 are arranged so as to extend tangentially or substantially tangentially to the first circle on which the fastening points of the horology movement 2 are inscribed.

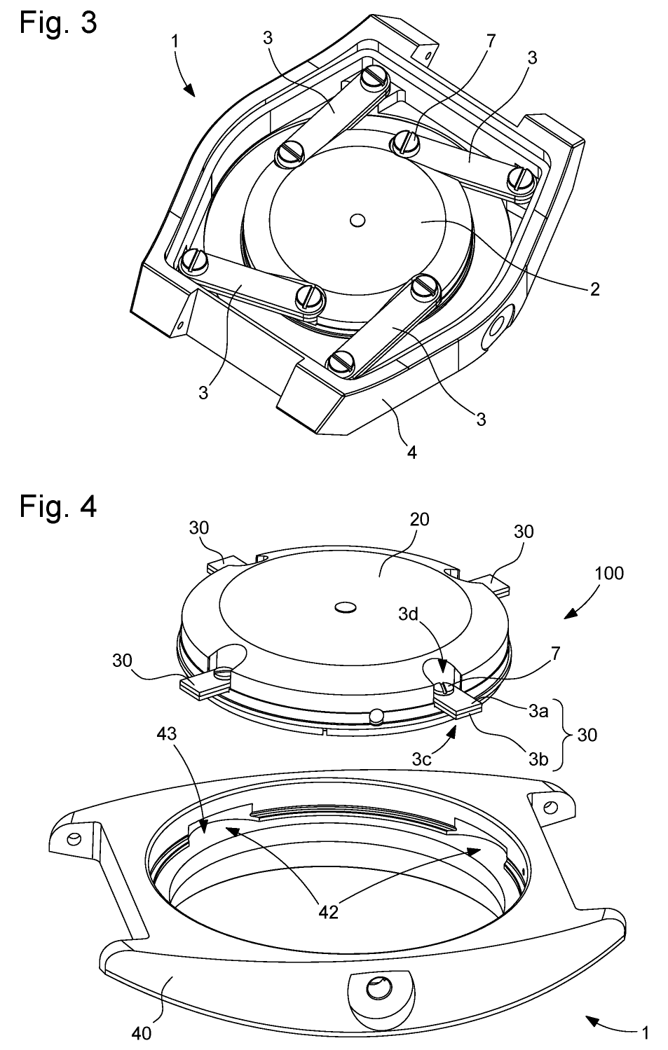

Referring now to FIGS. 2 and 3, once the stacks 3 have been fastened to the horology movement 2, the assembly formed by the horology movement 2 and the stacks 3 is fitted into a bed in the case middle 4.

According to the example shown, the case 4 has surfaces for holding and supporting the case ends 3c of the stacks 3. Preferably, the fastening points for the case are provided on these holding surfaces. Of course, the case 4 comprises at least as many holding surfaces as there are stacks 3 for fastening the horology movement 2.

FIG. 4 illustrates a second embodiment of the fastening device 100 according to the invention. This second embodiment is identical to the first embodiment described above, except for the stack clamping elements, which will be described in greater detail below. In this second embodiment, the fastening device 100 comprises at least one stack 30 formed by at least two blades 3a, 3b acting as a casing clamp for the horology movement 20.

In the embodiment shown, the fastening device 100 is formed by a plurality of stacks 30 of two superimposed blades 3a, 3b.

The movement end 3d of the stacks 30 is attached in the same way as in the first embodiment by fastening elements such as screws engaging with tappings forming the fastening points on the horology movement 20.

On the other hand, the case ends 3c are designed to engage with notches 42 made in the case, the notches 42 being arranged so that the stacks 30 forcefully hold the horology movement 20 by keeping it pressed against a shoulder 43 of the case 40.

The use of stacks with several blades makes it possible to increase the overall rigidity of the fastening clamps while limiting the space required. The invention therefore keeps the fastening clamps from bending. The use of stacks with several blades is advantageous irrespective of the method of fastening and/or clamping the stacks to the horology movement and the case.

In addition, stacks with several blades minimise the stresses on the fastening points of the stacks, and therefore on the screws, at iso shock. The fastening device according to the invention thus keeps the horology movement from detaching from the case if it is subjected to a shock.

Preferably, the fastening device can comprise one or more of the following manufacturing steps: water jet cutting, three-axis machining, machining, turning, laser cutting, stamping.

The above description of the invention is provided by way of example. It is understood that the person skilled in the art is capable of arriving at different variants of the invention without departing from the scope of the invention.

1. A device for fastening a horology movement designed to hold said horology movement in a case of a timepiece, comprising
at least one stack including at least two blades, said at least one stack having two opposite ends, a first case end and a second movement end; and
first fastening elements for fastening the second movement end of said at least one stack to the horology movement, said at least one stack being configured to rigidly hold said horology movement in the case.

2. The fastening device according to claim 1, further comprising second fastening elements for fastening the first case end of said at least one stack to the case.

3. The fastening device according to claim 1, wherein the first case end of said at least one stack is clamped to the case by engaging a notch in the case.

4. The fastening device according to claim 1, wherein said at least two blades in a stack are at least partially in contact with each other.

5. The fastening device according to claim 1, wherein said at least two blades in a stack are spaced apart by at least one spacer arranged between said at least two blades.

6. The fastening device according to claim 1, wherein said at least two blades have identical dimensions and/or identical mechanical properties.

7. The fastening device according to claim 1, wherein said at least two blades have different dimensions and/or different mechanical properties.

8. The fastening device according to claim 1, further comprising at least two stacks.

9. The fastening device according to claim 8, wherein said at least two stacks are arranged so as to form a circular repeating pattern.

10. The fastening device according to claim 8, wherein said at least two stacks are arranged angularly equidistant from each other around the horology movement.

11. The fastening device according to claim 1, wherein the first fastening elements comprise at least one screw.

12. The fastening device according to claim 2, wherein the second fastening elements comprise at least one screw.

13. The fastening device according to claim 1, wherein said at least two blades in said at least one stack comprise a material chosen among: steel, resilient steel, superelastic shape memory alloy, amorphous metal, nickel-based superalloy, iron-nickel-based superalloy, cobalt-based superalloy, spring steel, composite materials, or a mixture or combination thereof.

14. A timepiece comprising at least one horology movement and a case holding said horology movement, and further comprises the fastening device according to claim 1 connecting said horology movement to the case.
